(19) United States
(12) Patent Application Publication
(10) Pub. No.: US 2014/0178718 A1
(43) Pub. Date: Jun. 26, 2014

(54) ELECTROCHEMICAL DEVICE

(71) Applicant: TAIYO YUDEN CO., LTD., TOKYO (JP)

(72) Inventor: Koji KANO, Tokyo (JP)

(73) Assignee: TAIYO YUDEN CO., LTD., TOKYO (JP)

(21) Appl. No.: 14/138,649

(22) Filed: Dec. 23, 2013

(30) Foreign Application Priority Data
Dec. 21, 2012 (JP) 2012-278906

(51) Int. Cl. H01M 12/00

(52) U.S. Cl. CPC H01M 12/005
USPC 429/7

(57) ABSTRACT

An electrochemical device includes a positive electrode, a negative electrode, and an electrolyte solution. The positive electrode is formed of an electrode material including an anion doped conductive polymer. The negative electrode is formed of an electrode material capable of absorbing and releasing a lithium ion. The electrolyte solution includes a lithium ion and an anion, the electrolyte solution being in contact with the positive electrode and the negative electrode.

### CROSS-REFERENCE TO RELATED APPLICATION

This application claims the benefit under 35 U.S.C. §119 of Japanese Patent Application No. 2012-278906, filed Dec. 21, 2012, which is hereby incorporated by reference in its entirety.

### BACKGROUND

The present disclosure relates to an electrochemical device that uses a lithium ion.

A lithium ion capacitor (LIC) is a hybrid capacitor using a negative electrode of a lithium ion battery (LIB) and a positive electrode of an electric double layer capacitor (ECLC). In general, activated carbon having a large specific surface area, which includes carbon as a main component, is used for the positive electrode, and a carbon material that is capable of absorbing a lithium ion is used for the negative electrode. The lithium ion capacitor is charged by intercalating (or doping) a lithium ion contained in the positive electrode to the negative electrode during charging in the case where the positive electrode has a potential not more than a natural potential, and intercalating (or doping) a lithium ion in an electrolyte solution to the negative electrode in the case where the positive electrode has a potential not less than a natural potential. The negative electrode is charged by doping an Li ion adsorbed in the positive electrode during discharging and an Li ion in the electrolyte solution. (Japanese Patent Application Laid-open No. 2008-010682, Japanese Patent Application Laid-open No. 2001-512526)

### BRIEF SUMMARY

In order not to cause a capacity reduction and internal short-circuit in a charge and discharge cycle in a lithium ion battery and a lithium ion capacitor, there is a need that the area of the negative electrode is larger than that of the positive electrode and the negative electrode covers the entire surface of the positive electrode. If the area of the negative area is smaller than that of the positive electrode or the negative electrode does not cover the entire surface of the positive electrode, a lithium ion precipitates in the negative electrode as metal lithium and thus does not function as a lithium ion. Therefore, the capacity may be reduced and the increased precipitation may cause a short-circuit during charging. Because the area of the negative electrode needs to be larger than that of the positive electrode, the capacity is smaller than that of an electric double layer capacitor having a low design energy density regardless of the high energy density of the material in some cases if the size of the lithium ion capacitor is reduced.

In view of the circumstances as described above, it is desirable to provide an electrochemical device having a high capacity even if the size thereof is reduced.

According to an embodiment of the present disclosure, there is provided an electrochemical device including a positive electrode, a negative electrode, and an electrolyte solution.

The positive electrode is formed of an electrode material including an anion doped conductive polymer.

The negative electrode is formed of an electrode material capable of absorbing and releasing a lithium ion.

The electrolyte solution includes a lithium ion and an anion, the electrolyte solution being in contact with the positive electrode and the negative electrode.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a schematic diagram of an electrochemical device according to an embodiment of the present disclosure;

FIG. 2 is a schematic diagram of the electrochemical device according to the embodiment of the present disclosure;

FIG. 3 is a cyclic voltammogram of a conductive polymer suitable as an electrode material of a positive electrode of the electrochemical device according the embodiment of the present disclosure;

FIG. 4 is a table showing properties of the conductive polymer suitable as the electrode material of the positive electrode of the electrochemical device according the embodiment of the present disclosure; and

FIGS. 5a and 5b are each a schematic diagram showing an operation of the electrochemical device according to the embodiment of the present disclosure.

### DETAILED DESCRIPTION

An electrochemical device according to an embodiment of the present disclosure includes a positive electrode, a negative electrode, and an electrolyte solution.

The positive electrode is formed of an electrode material including an anion doped conductive polymer.

The negative electrode is formed of an electrode material capable of absorbing and releasing a lithium ion reversibly.

The electrolyte solution includes a lithium ion and an anion, the electrolyte solution being in contact with the positive electrode and the negative electrode.

According to this configuration, the lithium ion in the electrolyte solution is absorbed in the negative electrode during charging, and the anion in the electrolyte solution is doped in the positive electrode. The lithium ion is released from the negative electrode during discharging, and the anion is released from the positive electrode. Specifically, the negative electrode uses only the lithium ion in the charge and discharge cycle, and the positive electrode uses only the anion. Therefore, because the problem of the precipitation of the lithium ion released from the positive electrode due to the insufficient area of the negative electrode does not occur and the area of the positive electrode does not need to be smaller than that of the negative electrode, it is possible to attain a small-size electrochemical device having a high capacity.

The anion doped conductive polymer having a potential not less than −0.2 V of a reduction peak potential when a potential sweep is performed on the lithium can be used.

By using such a conductive polymer as the electrode material of the positive electrode, it is possible to make the positive electrode have a sufficiently high potential at an average voltage.

The anion doped conductive polymer may include any one of polyaniline, polythiol, and poly(3-hexylthiophene).

Such a conductive polymer is an anion doped conductive polymer having a potential not less than −0.2 V of a reduction peak potential when a potential sweep is performed on the lithium, and is used at a potential not less than about 3 V. Therefore, it is suitable for the electrode material of the positive electrode of the electrochemical device according to the embodiment of the present disclosure.

The positive electrode may be doped to have a potential not less than 3 V (vs. Li).

By doping the positive electrode to have a potential not less than 3 V (vs. Li), it is possible to attain an electrochemical device having a high initial capacity and also a stable capacity even after the charge and discharge cycle passes through.

The positive electrode may have an electrode area larger than that of the negative electrode.

As described above, the electrochemical device according to the embodiment of the present disclosure can have a high capacity even if the area of the positive electrode is larger than that of the negative electrode. On the other hand, in the case of the configuration in which the lithium released from the positive electrode is absorbed in the negative electrode as in the related art, the capacity is reduced due to the precipitation of lithium if the area of the positive electrode is larger than that of the negative electrode.

An electrochemical device according to an embodiment of the present disclosure will be described.

[Configuration of Electrochemical Device]

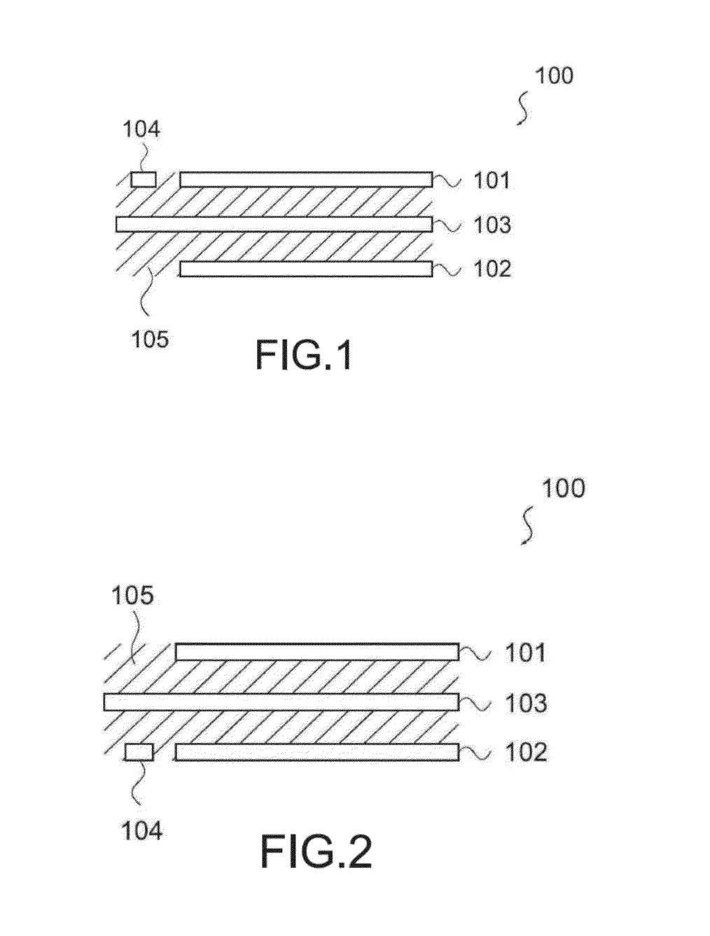

FIG. 1 and FIG. 2 are each a diagram showing an electrochemical device 100 according to an embodiment of the present disclosure. As shown in FIGS. 1 and 2, the electrochemical device 100 includes a positive electrode 101, a negative electrode 102, a separator 103, a reference electrode 104, and an electrolyte solution 105. They can be accommodated in a container (not shown). Moreover, the electrochemical device 100 may have a configuration in which a plurality of positive electrodes 101 and a plurality of negative electrodes 102 are laminated via a plurality of separators 103.

The positive electrode 101 is formed of an electrode material including an anion doped conductive polymer. The anion doped conductive polymer is a conductive polymer in which an anion can be doped, and the anion doped conductive polymer having a reduction potential not less than −0.2 V of the reduction peak potential when a potential sweep is performed on the lithium is favorably used. Although the details thereof will be described later, examples of the anion doped conductive polymer include polyaniline, polypyrrole, and poly(3-hexylthiophene). The potential can be adjusted by the conditions in the production process, chemical oxidation or electrolytic oxidation after the production, or the like.

Specifically, the positive electrode 101 can be obtained by resolving an anion doped conductive polymer and a binder in a solvent, applying it to metal foil such as aluminum foil, and drying it. Moreover, the positive electrode 101 can be obtained by dispersing an anion doped conductive polymer and a binder in a state of not being dissolved in water or a solvent, applying it to metal foil such as aluminum foil, and drying it, similarly to the above. Furthermore, the positive electrode 101 can be obtained by making an electrode material including an anion doped conductive polymer in a sheet-like shape and laminating it, for example. The positive electrode 101 is used in a state where an anion is doped and the positive electrode 101 has a potential not less than 3 V (vs. Li). The positive electrode 101 according to this embodiment can have the area not less than that of the negative electrode 102 because of the reasons to be described later.

The negative electrode 102 is formed of an electrode material that is capable of absorbing and releasing a lithium ion. Examples of the electrode material that is capable of absorbing and releasing a lithium ion include a carbon material such as graphite, graphitizable carbon, and non-graphitizable carbon, and a hydrocarbon material such as polyacene. In addition thereto, a material that is capable of absorbing and releasing a lithium ion reversibly can be used as the electrode material of the negative electrode 102.

Specifically, the negative electrode 102 can be obtained by mixing an electrode material that is capable of absorbing and releasing a lithium ion reversibly with a polymeric material, water, or a solvent to make it into a paste, applying it to metal foil such as copper foil, and drying it. Alternatively, the negative electrode 102 can be obtained by making an electrode material that is capable of absorbing and releasing a lithium ion reversibly in a sheet-like shape and laminating it, for example.

The separator 103 inhibits the positive electrode 101 from being brought into contact with the negative electrode 102 (insulation) and causes an ion included in the electrolyte solution 105 to transmit therethrough. The separator 103 can include a woven fabric, a non-woven fabric, a synthetic resin fine porous film, or the like.

The reference electrode 104 is an electrode for measuring a potential of the positive electrode 101 or the negative electrode 102, and can be formed of a conductive material such as metal lithium. As shown in FIG. 1, the reference electrode 104 may be provided on the side of the positive electrode 101 with respect to the separator 103. Alternatively, the reference electrode 104 may be provided on the side of the negative electrode 102 with respect to the separator 103. Moreover, the reference electrode 104 does not need to be provided in actual use.

The electrolyte solution 105 includes a lithium ion and an anion, and is in contact with the positive electrode 101 and the negative electrode 102. The electrolyte solution 105 can be an electrolyte solution including a lithium element such as LiPF6, LiC1O4, LiBF4, and LiAsF6. Because such an electrolyte ionizes, the electrolyte solution 105 includes a lithium ion (Li+) and an anion (PF6- or the like).

[Regarding Electrode Material of Positive Electrode]

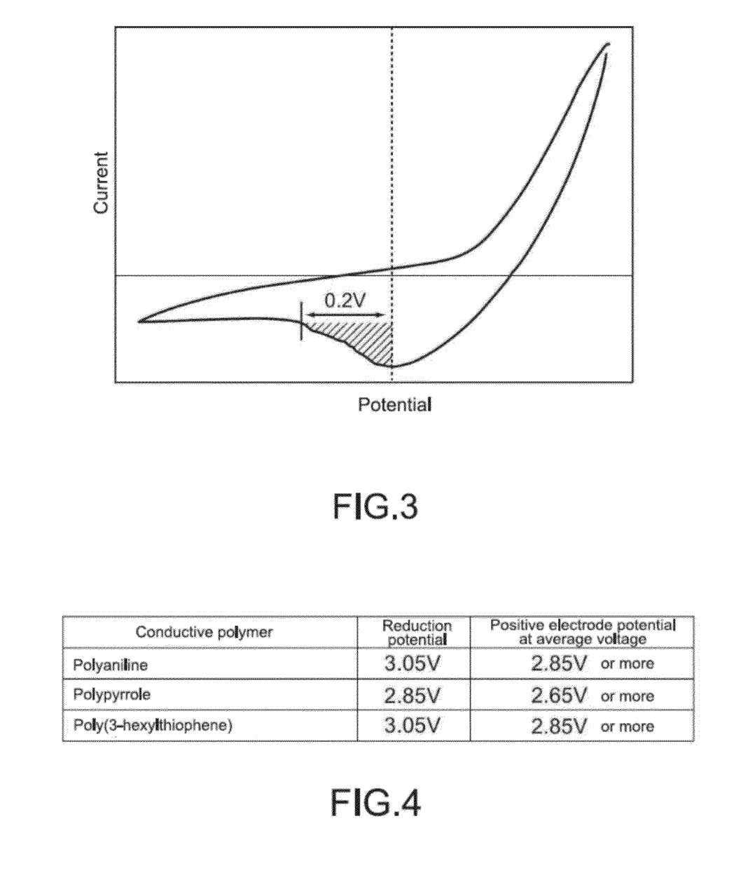

As described above, an anion doped conductive polymer being the electrode material of the positive electrode 101, which has a reduction potential not less than −0.2 V of the reduction peak potential when a potential sweep is performed on the lithium, is favorably used. FIG. 3 shows an example of a cyclic voltammogram obtained by a potential sweep. FIG. 3 is obtained by performing measurement using polyaniline as a working electrode, lithium as a counter electrode, and lithium as a reference electrode.

In the cyclic voltammogram, the potential at the downward peak (broken lines in FIG. 3) is a reduction peak potential being a potential at which most reactions are caused in the positive electrode. The range from −0.2 V of the reduction peak potential to the reduction peak potential, which corresponds to the diagonal line area shown in FIG. 3, is an effective range in which the reaction is continued (capacity can be obtained). FIG. 4 shows the reduction potentials of polyaniline, polypyrrole, and poly (3-hexylthiophene).

By using the conductive polymer as the electrode material of the positive electrode 101 in the range of a potential not less than −0.2 V of the reduction peak potential when a potential sweep is performed on the lithium, it is possible to achieve a high positive electrode potential at an average voltage. The positive electrode potential at an average voltage is a potential of the positive electrode at an average voltage, an average voltage of a cell is a central value between the upper limit and the lower limit in the case of a capacitor, and an average voltage of a battery can be obtained by the arithmetic average.

FIG. 4 shows the positive electrode potential at an average voltage when the positive electrode 101 is formed of an electrode material including each conductive polymer. Because any of the conductive polymers shown in FIG. 4 has a potential not less than −0.2 V of the reduction peak potential when a potential sweep is performed on the lithium, it is possible to achieve a high positive electrode potential at an average voltage, and the conductive polymers are suitable as the electrode material of the positive electrode 101.

[Operation of Electrochemical Device]

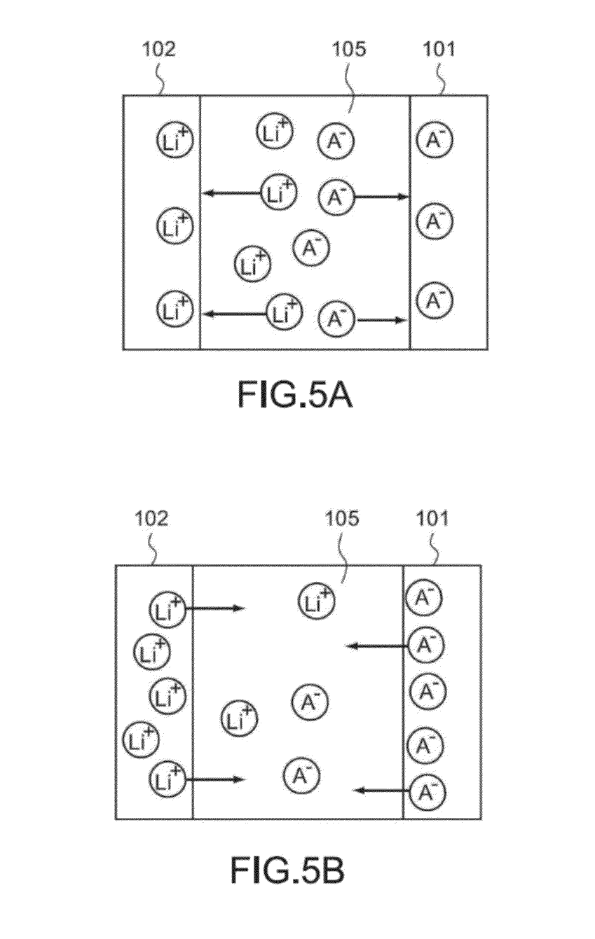

The operation of the electrochemical device 100 will be described. FIGS. 5 are each a schematic diagram showing the operation of the electrochemical device 100. FIG. 5A shows the operation of the electrochemical device 100 during charging, and FIG. 5B shows the operation of the electrochemical device 100 during discharging. It should be noted that in FIGS. 5A and 5B, illustrations of the separator 103 and the reference electrode 104 are omitted.

As shown in FIG. 5A, an anion (A−) is doped in the positive electrode 101 and a lithium ion (Li+) is absorbed in the negative electrode 102 at the start of charging. When charging is started, a lithium ion (Li+) in the electrolyte solution is absorbed in the negative electrode 102, and an anion (A−) in the electrolyte solution is doped in the positive electrode 101.

As shown in FIG. 5B, the anion (A−) doped in the positive electrode 101 is released to the electrolyte solution and the lithium ion (Li+) absorbed in the negative electrode 102 is released to the electrolyte solution during discharging. Hereinafter, in the charge and discharge cycle, the doping and releasing of the anion (A−) in the positive electrode 101 and the absorbing and releasing of the lithium ion (Li+) in the negative electrode 102 as described above are repeated.

As described above, in the electrochemical device 100 according to this embodiment, the positive electrode 101 uses only an anion and the negative electrode 102 uses only a lithium ion in the charge and discharge cycle. On the other hand, in the case of the existing configuration in which a lithium ion is supplied from the positive electrode to the negative electrode, the lithium ion precipitates on the end surface of the negative electrode if the area of the negative electrode is smaller than that of the positive electrode.

On the other hand, in the electrochemical device 100 according to this embodiment, because a lithium ion is not supplied from the positive electrode 101 to the negative electrode 102, the lithium ion does not precipitate on the negative electrode 102 even if the area of the negative electrode 102 is equal to or smaller than that of the positive electrode 101. Therefore, the area of the positive electrode 101 does not need to be smaller than that of the negative electrode 102 even in the case where the size of the electrochemical device 100 is reduced, and thus, it is possible to increase the capacity of the electrochemical device 100.

The present disclosure is not limited to the above-mentioned embodiments, and various modifications can be made appropriately without departing from the gist of the present disclosure.

### EXAMPLE

An example of the present disclosure will be described. In the following way, electrochemical devices according to the example and a comparative example of the present disclosure were created, and various measurements were performed.

The electrochemical device according to the example included the following positive electrode and negative electrode. The positive electrode was formed to have a predetermined thickness by repetitively applying the solution obtained by dissolving polyaniline (anion doped conductive polymer) and a binder in a solvent to etched aluminum foil (having a thickness of 30 μm) and drying it. The negative electrode was obtained by applying a slurry paste obtained by mixing non-graphitizable carbon, a conduction promoting agent, carboxymethyl cellulose, styrene-butadiene rubber, and water to copper foil (having a thickness of 15 μm) opened by etching (opening diameter of φ 0.15, opening ratio of 20%).

Materials were dried under reduced pressure at 140° C. for 12 hours in advance, and water contained in the materials was removed. The weight of the carbon material in the negative electrode, which is associated with charge and discharge, was calculated by weight measurement, the weight of metal lithium, which falls in the range of 80 to 90% of the maximum doping amount per weight (100%), was measured, and the metal lithium was applied to an uncoated surface of the negative electrode. A resin roller was used in the range in which the resin roller could be handled to extend the metal lithium as thin as possible by applying pressure. An electrolyte solution including a lithium ion was filled between these positive electrode and negative electrode, and thus, the electrochemical device according to the example was obtained. The electrochemical device thus created was used for an evaluation after the lithium was confirmed to be predoped in the negative electrode. An indication of a potential is not more than 0.05 V of the lithium potential of the reference electrode.

The electrochemical device according to the comparative example included the following positive electrode and negative electrode. The positive electrode was obtained by making a material obtained by kneading activated carbon, carbon black, and PTFE (polytetrafluoroethylene) into a sheet and applying it to etched aluminum foil (having a thickness of 30 μm). The negative electrode had the same configuration as the negative electrode according to the example. The same electrolyte solution as that of the electrochemical device according to the example was filled between these negative electrode and positive electrode, and thus, the electrochemical device according to the comparative example was obtained.

In the electrochemical devices according to the example and the comparative example created as described above, cells were created so that the area of the positive electrode is smaller than that of the negative electrode and different cells were created so that the area of the positive electrode is larger than that of the negative electrode. Whether proper charging was performed or not was evaluated in the charging process. In the case where the area of the positive electrode is larger than that of the negative electrode, it was possible to perform proper charging in the electrochemical device according to the example, but a problem of intermittent reduction of a voltage for a short time period was recognized during constant voltage charge in constant voltage and constant current charge in the electrochemical device according to the comparative example.

As described above, because the area of the negative electrode is small in the electrochemical device according to the comparative example, a lithium ion supplied from the positive electrode precipitates as metal lithium, which causes the reduction of a voltage. On the other hand, in the electrochemical device according to the example, it was confirmed that lithium does not precipitate and the reduction of a voltage is not caused even if the area of the positive electrode is larger than that of the negative electrode.

Moreover, the electrochemical devices according to the example, which include positive electrodes having different doping ratios of a conductive polymer by the condition during synthesizing, were created. The potential of the positive electrode having a low doping ratio of a conductive polymer was 2.7 V, 20 days after the experimental production of the cell. On the other hand, the potential of the positive electrode having a high doping ratio of a conductive polymer was 2.9 V, 20 days after the experimental production of the cell. The potentials of the negative electrodes measured at the same time were 0.04 V and 0.05 V.

When the charge and discharge cycle was performed in the electrochemical devices, the initial capacity was about 70% of the design capacity in the case of the positive electrode having a low doping ratio of a conductive polymer. Although the capacity was recognized to be increased when the charge and discharged was repeated, the capacity of only about 80% of the design capacity was obtained. On the other hand, the initial capacity was the same as that of the design capacity in the case of the positive electrode having a high doping ratio of a conductive polymer, and a stable capacity could be obtained after that.

As described above, because the electrochemical device according to the example of the present disclosure uses a positive electrode formed of an electrode material including an anion doped conductive polymer, the area of the negative electrode does not need to be larger than that of the positive electrode unlike the existing configuration. Furthermore, it is possible to achieve favorable properties of the electrochemical device by increasing the doping ratio of an anion doped conductive polymer being an electrode material of the positive electrode.

The present disclosure contains subject matter related to that disclosed in Japanese Priority Patent Application JP 2012-278906 filed in the Japan Patent Office on Dec. 21, 2012, the entire content of which is hereby incorporated by reference.

What is claimed is:

1. An electrochemical device, comprising:
a positive electrode formed of an electrode material including an anion doped conductive polymer;
a negative electrode formed of an electrode material capable of absorbing and releasing a lithium ion; and
an electrolyte solution including a lithium ion and an anion, the electrolyte solution being in contact with the positive electrode and the negative electrode.

2. The electrochemical device according to claim 1, wherein the anion doped conductive polymer has a potential not less than −0.2 V of a reduction peak potential when the device is maintained at an average operating voltage.

3. The electrochemical device according to claim 2, wherein the anion doped conductive polymer includes any one of polyaniline, polythiol, and poly(3-hexylthiophene).

4. The electrochemical device according to claim 1, wherein the positive electrode is doped to have a potential not less than 3 V (vs. Li).

5. The electrochemical device according to claim 1, wherein the positive electrode has an electrode area larger than that of the negative electrode.
